(19) United States
(12) Patent Application Publication
(10) Pub. No.: US 2013/0127753 A1
(43) Pub. Date: May 23, 2013

(54) SETTING METHOD AND SYSTEM FOR ACTUATING POSITION OF ELECTRONIC DEVICE

(71) Applicant: Asustek Computer Inc., Taipei (TW)

(72) Inventors: Hsiao-Kai LI, Taipei (TW); Wen-Chieh TSENG, Taipei (TW); Kuo-Chung CHIU, Taipei (TW)

(73) Assignee: ASUSTEK COMPUTER INC., Taipei (TW)

(21) Appl. No.: 13/675,856

(22) Filed: Nov. 13, 2012

Related U.S. Application Data
(60) Provisional application No. 61/562,799, filed on Nov. 22, 2011.

(51) Int. Cl. G06F 3/041

(52) U.S. Cl. CPC G06F 3/041
USPC 345/173

(57) ABSTRACT

A setting method for an actuating position of an electronic device is disclosed, which includes the steps of: providing an operation interface having the actuating position, and the actuating position having a first function; touching the actuating position; touching a customized actuating position to set a corresponding relation between the actuating position and the customized actuating position; and saving the corresponding relation. The setting method allows users to define a customizable actuating position of a touch screen in order to operate an interface of each application more intuitively, and has the effects of enhancing the use efficiency and comfortability.

### CROSS REFERENCE TO RELATED APPLICATIONS

The non-provisional patent application claims priority to U.S. provisional patent application with Ser. No. 61/562,799 filed on Nov. 22, 2011. This and all other extrinsic materials discussed herein are incorporated by reference in their entirety.

### BACKGROUND OF THE INVENTION

1. Field of Invention

This disclosure relates to a setting method for an actuating position of an electronic device and, in particular, to a method for customizing an actuating position of an electronic device.

2. Related Art

In the modern market with various consumer electronic products, portable electronic products, such as a personal digital assistant (PDA), a mobile phone, a global positioning system (GPS), a digital audio-video player and the like, have used touch panels as man-machine data communicating interfaces. The conventional input devices, such as the keyboard and the mouse, have been replaced with the touch means, and the touch device and the display panel are integrated together to save the space. The saved space may be provided for the display space with the larger area, and enlarge the display area.

With the advancement of technology and the rapid development of various applications (Apps), the operation methods and functions of the touch screen are getting more and more diversified. However, the current touch screen informs the application on the electronic device about the touched coordinates by way of absolute positions, and the application programmer firstly decides the position of each function button in the software development stage. The user only can operate the application according to the software programmer's design. That is, the user cannot select, insert or replace different touch gestures in different touch areas.

However, not all software man-machine interface (MMI) designs have considered the human engineering layer. In addition, because different electronic devices have different screen resolutions or sizes, the user tends to feel inconvenient or uncomfortable upon operation, thereby decreasing the degrees of freedom upon operation.

### SUMMARY OF THE INVENTION

A setting method for an actuating position applicable to an electronic device is disclosed. The setting method comprising the steps of: providing an operation interface having the actuating position, and the actuating position having a first function; touching the actuating position; touching a customized actuating position to set a corresponding relation between the actuating position and the customized actuating position; and saving the corresponding relation.

In one embodiment, the corresponding relation comprises making the actuating position and the customized actuating position have the first function concurrently after the customized actuating position is touched.

In one embodiment, the customized actuating position has a second function before being touched.

In one embodiment, the corresponding relation comprises making the actuating position and the customized actuating position have the first function concurrently after the customized actuating position is touched.

A method for customizing an actuating position of an electronic device is disclosed. The method comprising the steps of providing an operation interface having the actuating position; and setting corresponding relations between the actuating position and multiple customized actuating positions. Herein, the step of setting the corresponding relations comprises the sub-steps of touching the actuating position, wherein the actuating position has a first function; touching one of the customized actuating positions; saving a corresponding relation between the actuating position and the one of the customized actuating positions; and repeating the sub-steps of touching, touching and saving until the corresponding relations between the customized actuating positions and the actuating position have been set and saved.

In one embodiment, after the step of setting corresponding relations between the actuating position and the multiple customized actuating positions, the actuating position and the customized actuating position have the first function concurrently.

A system for customizing an actuating position of an electronic device is also disclosed. The system comprises a touch module, a sensing module, a processing module, and a memory module. The touch module has at least an actuating position and at least a customized actuating position. The sensing module is coupled to the touch module. When the actuating position is touched, the sensing module is triggered to output a first signal, and when the customized actuating position is touched, the sensing module is triggered to output a second signal. The processing module is coupled to the sensing module for receiving the first signal and the second signal outputted from the sensing module, and completing a setting of a corresponding relation between the actuating position and the customized actuating position according to the first signal and the second signal. The memory module is coupled to the processing module and saves the setting.

As mentioned above, using the customizing method provided by this disclosure allows users to decide operation positions on a touch interface of an electronic device for each function. That is, the customizing method can change the touch operation positions for the functions of different actuating positions and is advantageous to the users who want to define the positions of each function to the positions where the users get used to and can operate conveniently.

More importantly, using the setting method for the actuating position according to the disclosure can perform the definitions on each application respectively and independently, and then save the definitions through the memory module, so that the above-mentioned settings can be accessed in the subsequent operations, and the files with the customized actuating positions can be correspondingly generated according to each of the setting applications. When the set application is opened at the next time, the electronic device automatically reads the defined files without the second setting. Overall speaking, the method of customizing the actuating position of the electronic device enables the users to operate the operation interface of each application more intuitively, and thus has the advantages of enhancing the use efficiency and convenience.

### BRIEF DESCRIPTION OF THE DRAWINGS

FIG. 1A is a flow chart showing steps of a method of customizing an actuating position of an electronic device according to a preferred embodiment of the disclosure;

FIG. 1B is a schematic illustration showing the method of FIG. 1A of customizing the actuating position of the electronic device applied to the electronic device;

FIG. 1C is a system block diagram showing the electronic device of FIG. 1B;

FIG. 2A is a flow chart showing steps of a method of customizing an actuating position of an electronic device according to another preferred embodiment of the disclosure;

FIG. 2B is a schematic illustration showing the method of FIG. 2A of customizing the actuating position of the electronic device applied to a touch screen; and

FIG. 3 is a schematic illustration showing an application of the method of customizing an actuating position of an electronic device according to another preferred embodiment of the disclosure.

### DETAILED DESCRIPTION OF THE INVENTION

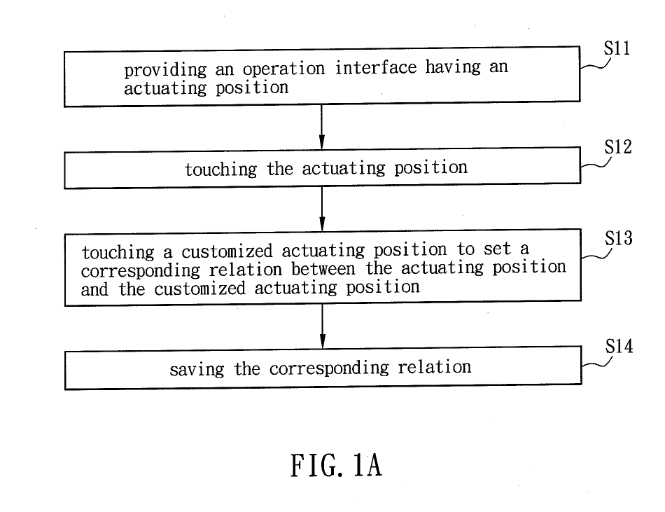

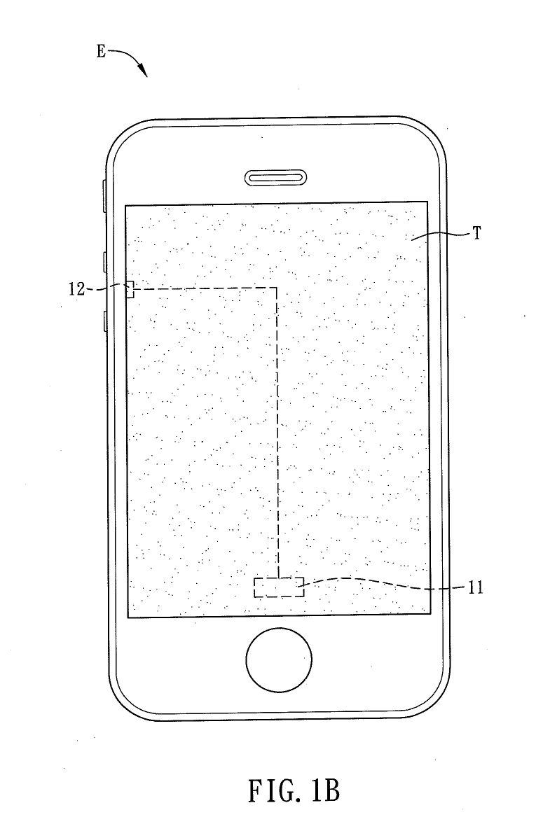

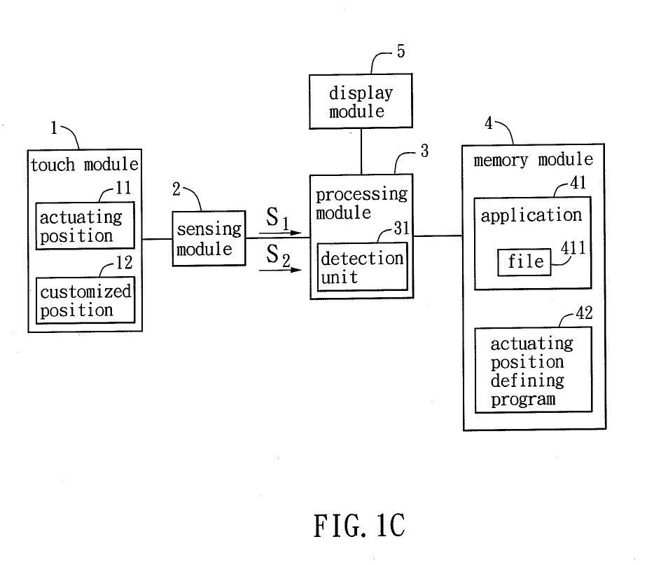

FIG. 1A is a flow chart showing steps of a method of customizing an actuating position of an electronic device according to a preferred embodiment of the disclosure. Referring to FIG. 1A, the method of customizing an actuating position of an electronic device includes the steps of: providing an operation interface having an actuating position (S11); touching the actuating position (S12); touching a customized actuating position to set a corresponding relation between the actuating position and the customized actuating position (S13); and saving the corresponding relation (S14). The actuating position has a first function.

In order to make associated details of each step of implementing the method become clearer, how the method of the disclosure is implemented will be specifically described in conjunction with an electronic device E having a touch screen T. However, it is to be specified that the contents of the following embodiment are only for the illustrative purpose only, but do not intend to restrict the disclosure.

FIG. 1B is a schematic illustration showing the method of FIG. 1A of customizing the actuating position of the electronic device applied to the electronic device, and FIG. 1C is a system block diagram showing the electronic device of FIG. 1B. Please refer to FIGS. 1A to 1C simultaneously. In this embodiment, the electronic device E is, for example but without limitation to, a portable phone, a personal digital assistant (PDA), a notebook computer or a tablet computer having a touch screen.

The electronic device E includes a touch module 1, a sensing module 2 and a processing module 3. The sensing module 2 is connected to the touch screen T and coupled to the touch module 1. The touch module 1 is electrically connected to the sensing module 2. When the touch module 1 is touched, the sensing module 2 is triggered to output a signal to the processing module 3.

The touch screen T may be a resistive or a capacitive touch screen, and the touch module 1 can define more than one specific touch area, such as an actuating position 11 shown in FIG. 1B. The actuating position 11 is a specific touch area on the touch module 1 and is provided for the user to input and define the touch operation. It is to be specified that the number of the touch areas that can be defined by the touch module 1 of this disclosure is not restricted to one single actuating position 11, and the touch module 1 may further include several actuating positions for the touch operations.

The processing module 3 has a detection unit 31, which corresponds to the sensing module 2 and is disposed in the touch screen T. In practice, the processing module 3 may include an application. So, when the application is drafted, the detection unit 31 may be configured to be capable of receiving the signal outputted from the sensing module 2. For example, when the actuating position 11 is touched, the sensing module 2 is triggered to output a first signal 51, and the processing module 3 can receive and convert the first signal S1 into an execution command controlling the electronic device E to execute a function.

In practice, the electronic device E further includes a memory module 4 and a display module 5. The memory module 4 is used for accessing each application or software in the electronic device E or the files of multiple electronic devices E. In one embodiment, the method of this disclosure for customizing the actuating position of the touch screen is used in conjunction with an actuating position defining program 42 in the memory module 4. Using the actuating position defining program 42 allows the user to define the operation interface of each application in the electronic device E.

For example, when the user wants to define an application with an image capturing function in the electronic device E, the actuating position defining program 42 may be used to perform the actuating position setting of each operation unit (e.g., a capturing unit, an editing unit, a clearing unit or the like) in the application. That is, the coordinate position of the operation unit in each application in the electronic device E can be defined through the method for customizing the actuating position of the electronic device, so as to satisfy the user's operation habit or operation convenience.

In addition, when the processing module 3 reads the message outputted from the memory module 4, a frame is correspondingly displayed on the display module 5 for the operator to watch and perform the man-machine interaction. Each operation interface and each display screen in this disclosure are represented by the above-mentioned display module 5.

The method of the disclosure for customizing the actuating position of the electronic device will be described by taking the electronic device E of FIG. 1B as an example in conjunction with FIGS. 1A and 1C. However, the method of the disclosure for operating the touch screen is not particularly restricted to the electronic device E shown in FIG. 1B.

In the step S11 of this embodiment, an operation interface 41a is provided. The operation interface 41a has the actuating position 11. In detail, the step S11 extracts and opens the operation interface 41a (for example but without limitation to the operation interface 41a of an application 41) from the memory module 4 through the processing module 3. The application includes, for example but without limitation to, a word processing application, a communication application, an image capturing application, a game application or the like. Herein, the “open” operation means actuating the application 41 and displaying its actuating frame through a touch event or any other command.

After the operation interface 41a is opened, the function of customizing the actuating position on the operation interface 41a is enabled. In this embodiment, the function of customizing the actuating position may be performed through, for example but without limitation to, one actuating position defining program 42.

In detailed, after the processing module 3 receives the actuation of the step S11, it further extracts and executes the actuating position defining program 42 from the memory module 4 for the user to start to execute the function of customizing the actuating position. The actuating position defining program 42 of this embodiment after being opened generates an indication interface for guiding the user to perform the operation on the touch screen T. Herein, the operation interface guides the user to perform the operation by way of texts, images or marks, and this is advantageous to the enhancement of the intuition and convenience of operation. However, this does not intend to restrict the disclosure, and any interface capable of guiding the user, or any simple interface without any guidance to simplify the overall visual effect may also be included therein, and the disclosure is not particularly restricted thereto.

After the actuating position defining program 42 is opened through the above-mentioned method, the operation unit to be defined by the user in the application 41 is set. It is to be particularly stated that using the actuating position defining program 42 to execute the method of customizing the actuating position of the electronic device allows the user to define the function, possessed by any actuating position on the touch screen T, to the customized actuating position that is get used to or loved by another user. In the following, it is described how the actuating position defining program 42 is executed to define the function, possessed by the actuating position 11 on the touch screen T, to a first customized actuating position 12.

In this embodiment, the user touches the actuating position 11 in the step S12. The sensing module 2 senses the touching event in the step S12 and outputs the first signal S1 to the processing module 3, wherein the first signal S1 may be temporarily stored in the processing module 3. The actuating position 11 is the operation unit having the first function in the above-mentioned application 41. For example, when the operation unit is an image capturing unit, the first function is to execute the function of capturing an image or photographing.

Next, in the step S13, a customized actuating position is touched to set the corresponding relation between the actuating position and the customized actuating position. For example, the first customized actuating position 12 of this embodiment is touched so that the first customized actuating position 12 correspondingly has the first function. In detail, the sensing module 2 senses the touching event in the step S13 and outputs a second signal S2 to the processing module 3. When the processing module 3 receives the second signal S2 generated with the first signal S1, it compares the first signal S1 with the second signal S2, performs the associated processing, and outputs a command to make the first customized actuating position 12 have the first function, and then outputs a file 411 to the memory module 4 for saving the file 411 after the processing is finished, so that the setting may be accessed in the subsequent operation.

In this embodiment, the file 411 is accessed according to the application 41 serving as a directory. That is, after the above-mentioned setting of the actuating position defining program 42, the defined file 411 pertaining to the application 41 may be accessed according to the type of the opened application 41 in the step S11. However, this does not intend to restrict the disclosure. In the practical application, the user can open another application, perform the above-mentioned setting and access the file corresponding to the application.

As mentioned hereinabove, after the definition of the actuating position is finished, the step S14 saves the file 411 corresponding to the application 41. After the access is finished, the actuating position defining program 42 will not be opened again when the same application 41 is opened at the next time. However, it is to be particularly specified that a clearing command may also be provided through the actuating position defining program 42 to indicate the processing module 3 to delete the file 411 from the memory module 4. After the file 411 is deleted, the actuating position defining program 42 is again opened therewith so that the user can perform the reset when the application 41 is opened at the next time.

In this embodiment, the first customized actuating position 12 does not have any corresponding function before the touching event occurs. After the touching event occurs, both the first customized actuating position 12 and the actuating position 11 may have the first function concurrently. However, this does not intend to restrict the disclosure. In the practical application, the first customized actuating position 12 may also have a second function before the touching event occurs. After the touching event occurs, the first function overwrites the second function. That is, the actuating position 11 and the first customized actuating position 12 have the first function concurrently. Utilizing the method for customizing the actuating position of the electronic device can overwrite the defined setting of each position, and this is advantageous to the user who can intuitively perform the operation and setting.

However, it is to be particularly stated that no matter how the corresponding arrangement between each actuating position and each customized actuating position is, the function possessed by each customized position is based on the last setting. That is, when the actuating position corresponding to a certain customized actuating position has the photographing function, the customized actuating position has the photographing function.

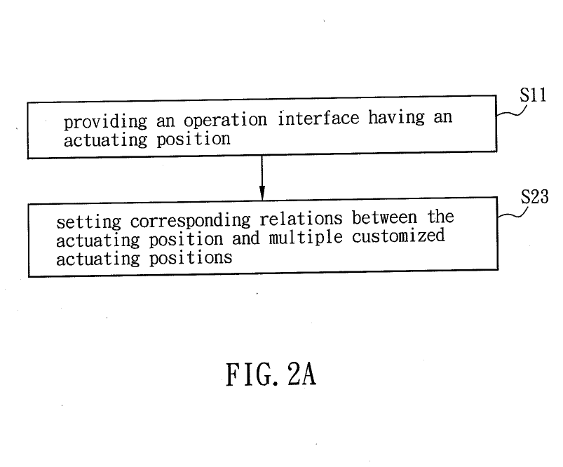

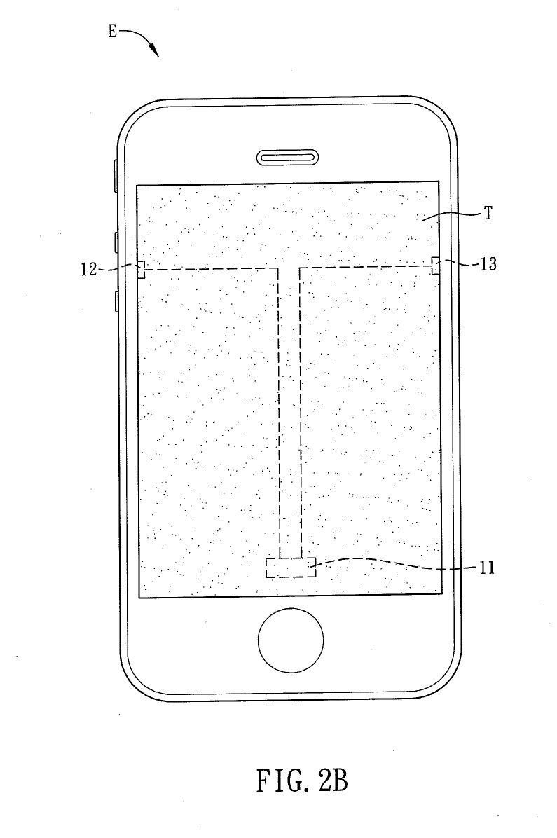

FIG. 2A is a flow chart showing steps of a method of customizing an actuating position of an electronic device according to another preferred embodiment of the disclosure, and FIG. 2B is a schematic illustration showing the method of FIG. 2A of customizing the actuating position of the electronic device applied to a touch screen. Please refer to FIGS. 1C, 2A and 2B concurrently. In this embodiment, the method for customizing the actuating position of the electronic device is substantially the same as the step S11 of the above-mentioned embodiment except that a step S23 is performed after the step S11 to set the corresponding relations between the actuating position 11 and multiple customized actuating positions. The step S23 sequentially includes the sub-steps of touching the actuating position 11 having a first function; touching one of the customized actuating positions; saving the corresponding relation between the actuating position 11 and the one of the customized actuating positions; and repeating the above-mentioned sub-steps until the corresponding relations between the customized actuating positions and the actuating position 11 have been saved. Compared with the above-mentioned embodiment, this embodiment has two customized actuating positions, which are a first customized actuating position 12 and a second customized actuating position 13, respectively, for example.

In detailed, the step S23 further sequentially includes the sub-steps of touching the actuating position 11 having the first function, touching the first customized actuating position 12, and saving the corresponding relation between the actuating position 11 and the first customized actuating position 12. Then, the above-mentioned sub-steps are repeated by sequentially touching the actuating position 11, touching the second customized actuating position 13 and saving the corresponding relation between the actuating position 11 and the second customized actuating position 13. Thus, the actuating position 11 having the first function can correspond to various customized actuating positions, and the customized actuating positions simultaneously have the first function. That is, repeatedly executing the method for customizing the actuating position of the electronic device can make multiple customized actuating positions have the operation function of the same actuating position. This is advantageous to different habits of different users, and the customized actuating positions are configured to satisfy the requirement of a left-handed user or a right-handed user.

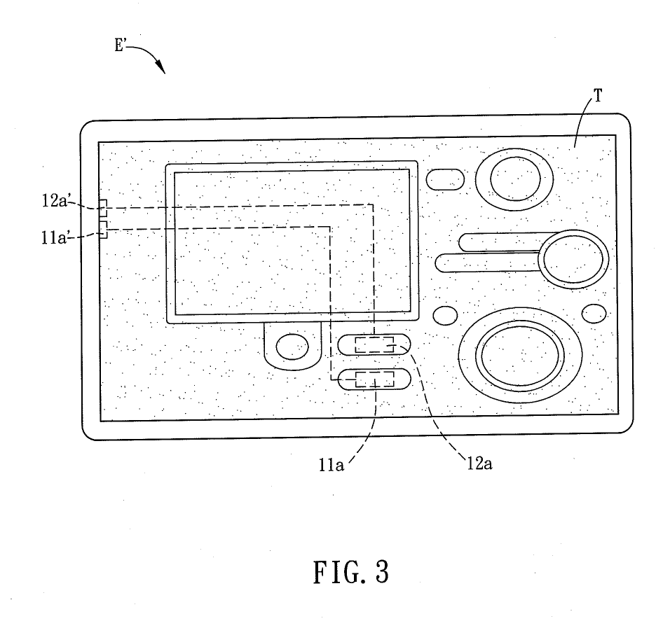

FIG. 3 is a schematic illustration showing an application of the method of customizing an actuating position of an electronic device according to another preferred embodiment of the disclosure. As shown in FIG. 3, the method for customizing the actuating position of the electronic device according to this embodiment of the disclosure is applied to an electronic device E′ having the method for setting the actuating position of the electronic device E′, and the method is substantially the same as that of the above-mentioned embodiment, so detailed descriptions thereof will be omitted. In the following, only the defined requirements on the electronic device E′ will be described.

Referring to FIG. 3, the electronic device E′ operates in conjunction with the method for customizing the actuating position of the electronic device. First, an application is opened. In this embodiment, for example, two actuating positions in the application will be described. In the practical application, however, the number of the actuating positions may be changed according to the function of the application, and the disclosure is not particularly restricted thereto.

In one embodiment, after the application is opened, the actuating position defining program is opened therewith. At this time, the user can input a first touching event to a first actuating position 11a having a first function, and then input a second touching event to a first customized actuating position 11a′ through the guidance of the indication interface of the actuating position defining program. After the setting is finished, the corresponding settings of the first actuating position 11a and the first customized actuating position 11a′ are saved. At this point, the first actuating position 11a and the first customized actuating position 11a′ have the first function concurrently.

Similarly, a function of a second actuating position 12a may also be correspondingly set to a second customized actuating position 12a′ through the above-mentioned method, so that the second actuating position 12a and the second customized actuating position 12a′ have the function of the second actuating position 12a concurrently. However, this does not intend to restrict the disclosure. In the practical application, the function of the first actuating position 11a may also be correspondingly set to the second customized actuating position 12a′ through the above-mentioned method, and the function of the second actuating position 12a may also be correspondingly set to the first customized actuating position 11a′. However, this disclosure is not particularly restricted thereto, and the setting conditions are determined according to the user's habit and the convenience in use.

The disclosure further provides a system for customizing the actuating position of the electronic device, and the system executes the above-mentioned method. Because the detailed descriptions of the method have been described hereinabove, the descriptions thereof will be omitted herein.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A setting method for an actuating position applicable to an electronic device, the method comprising the steps of:
providing an operation interface having the actuating position, and the actuating position having a first function;
touching the actuating position;
touching a customized actuating position to set a corresponding relation between the actuating position and the customized actuating position; and
saving the corresponding relation.

2. The method according to claim 1, wherein the corresponding relation comprises making the actuating position and the customized actuating position have the first function concurrently after the customized actuating position is touched.

3. The method according to claim 1, wherein the customized actuating position has a second function before being touched.

4. The method according to claim 3, wherein the corresponding relation comprises making the actuating position and the customized actuating position have the first function concurrently after the customized actuating position is touched.

5. A method for customizing an actuating position of an electronic device, the method comprising the steps of
providing an operation interface having the actuating position; and
setting corresponding relations between the actuating position and multiple customized actuating positions, wherein the step of setting the corresponding relations comprises the sub-steps of
touching the actuating position, wherein the actuating position has a first function;
touching one of the customized actuating positions;
saving a corresponding relation between the actuating position and the one of the customized actuating positions; and
repeating the sub-steps of touching, touching and saving until the corresponding relations between the customized actuating positions and the actuating position have been set and saved.

6. The method according to claim 5, wherein after the step of setting corresponding relations between the actuating position and the multiple customized actuating positions, the actuating position and the customized actuating position have the first function concurrently.

7. A system for customizing an actuating position of an electronic device, the system comprising:
a touch module having at least an actuating position and at least a customized actuating position;
a sensing module coupled to the touch module, wherein when the actuating position is touched, the sensing module is triggered to output a first signal, and when the customized actuating position is touched, the sensing module is triggered to output a second signal;
a processing module, which is coupled to the sensing module, receives the first signal and the second signal outputted from the sensing module, and completes a setting of a corresponding relation between the actuating position and the customized actuating position according to the first signal and the second signal; and
a memory module coupled to the processing module and saving the setting.
